(19) United States
(12) Patent Application Publication
(10) Pub. No.: US 2008/0144907 A1
(43) Pub. Date: Jun. 19, 2008

(54) Devices and Methods for Reconstructing Three Dimensional Images

(76) Inventor: Ein-Yiao Shen, Taipei (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/554,562

(22) Filed: Oct. 30, 2006

(51) Int. Cl. G06K 9/00

(52) U.S. Cl. 382/131

(57) ABSTRACT

The present invention relates to a device and a method for reconstructing three dimensional (3D) images form plural of two dimensional (2D) images in succession.

### FIELD OF THE INVENTION

The present invention relates to a device and a method for reconstructing three dimensional (3D) images form plural of two dimensional (2D) images in succession.

### BACKGROUND OF THE INVENTION

The medical image is very important in the digital era, Especially, the digitization is an inevitable result about medical image technology in the near future. As long as doctors input a patient's data such as an anamnesis numbers by a computer, they can immediately see every image of his physical examinations to give a diagnosis. Digital Images can reduce waiting time of patients, improve work efficiency and significantly decrease manpower costs.

In the 21^{st} century, the goal of image diagnosis is to digitalize traditional X-ray photography, to improve multi-functional image processor and speed of digital images of every scanning technique such as CT, MRI, PET, ultrasound to integrate development and application of medical image and acquisition system.

From the viewpoint of the image diagnosis operation, it can be classified into three parts as follows:
(a) generation of image,
(b) perception of image, and
(c) interpretation and communication of image.

The (a)-(c) can influence diagnostic quality.

General techniques of medical image acquisition mainly comprise of computed tomography (CT), magnetic resonance imaging (MRI), nuclear medicine (NM) and ultra-sound (US). Generally these images are the images of a certain section on a object to be photographed and are expressed to two dimensional (2D) image.

The present medical image acquisition techniques indeed contain great parts of patients' data after machines scanning. However, only 2D images as the basis of doctors' diagnosis cannot completely meet doctors' demands. In addition, it may result in producing blind spots to increase some uncertain risk.

Currently, 2D images of medicine have not solved medical treatment problems. If a computer could be applied to construct a series of images from CT or MRI and to show 3D human organ on a monitor, it can make a doctor directly observe 3D human organ of a patient. Doctors no longer make a guess but a decision at diagnosis by 3D images.

Nevertheless, the current 3D image methods show external profile of an object by a single frame or a single displaying formula or transform 2D successive slices into 3D-volumetric model and so-called 4D dynamic images or 3D plus time by adding the factor time. These methods and forms actully increase utility of 2D images. However, it is still hard to overcome accuracy of generating 3D images and easily read for these images. The above defects limit benefit of the routine discrimination automation. (K park et al., Volumetric heart model and analysis, Communications of the ACM February 2005/Vol. 48, NO. 2. pps. 43-47).

The reason why 3D images reconstruction techniques cannot meet the current practical requirements as follows:
1. limitation of obtaining high resolution of 2D scanning images,
2. errors and bad quality by moving measured objects, and
3. heterogeneity of scanning magnetic field, leading to errors of signal strength in different regions but in the same tissue.

Three-dimensional (3D) image processing technology is commonly used in scientific research as well as in movies, video games, and industrial planning. Since the late 1980s, 3D imaging technology has also been applied to various fields within medicine, such as fetal ultrasonography, cosmetic planning, biopsy guides, and stereo-guided neurosurgery. For years, neuroscience and related disciplines have also employed 3D imaging technology to examine the brain and its pathology.

The volume CT or multidetector (MD) CT scan is currently available for processing 3D reconstructed images in clinical practice. However, this advanced technology requires expensive facilities and well-trained technical personnel. This makes it difficult to provide 3D image reconstruction services at many hospitals. This issue is especially apparent in hospitals located in rural areas.

### BRIEF DESCRIPTION OF THE DRAWINGS

FIG. 1 shows the successive 2D images by computer aided tomography (CAD) before 3D images reconstruction of the invention.

FIG. 2 shows 3D neuroimaging conducted on a 6-year-old boy with normal brain structures. Volume and histogram of each component is shown: (a) gray matter (b) white matter (c) ventricles (d) vessels. Volume (cm³) is shown on the bottom, and histograms are shown on top.

FIG. 3 illustrates the volume analysis of the reconstructed 3D image.

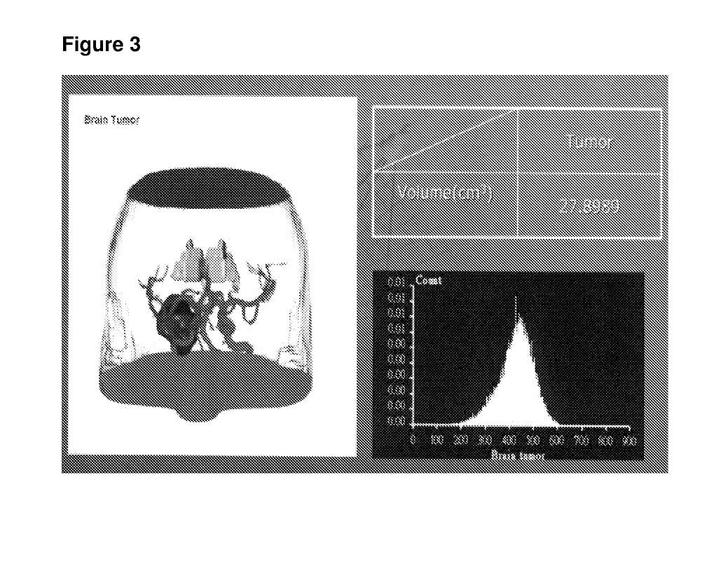

FIG. 4 depicts the histogram analysis of the reconstructed 3D image.

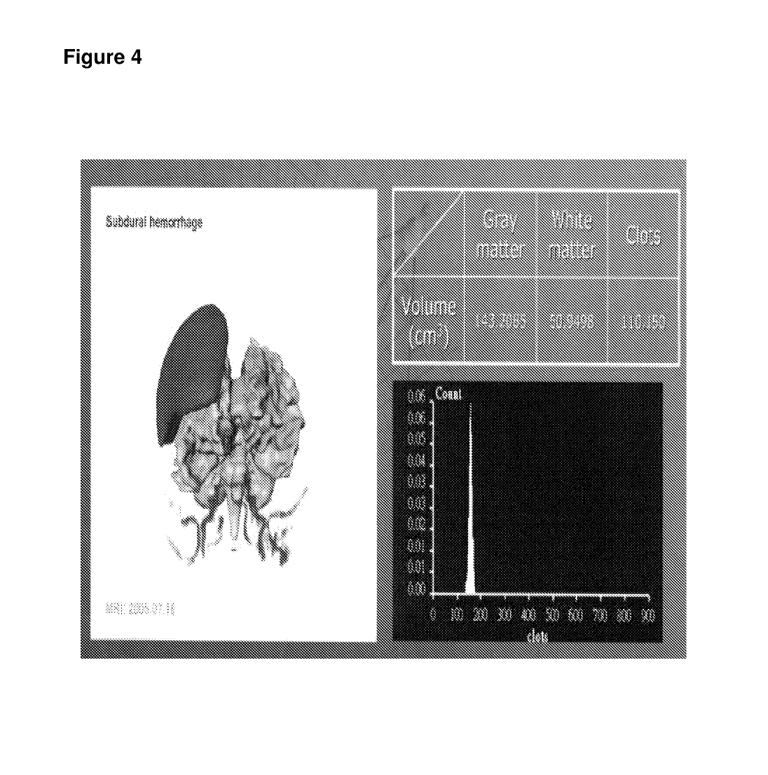

### SUMMARY OF THE INVENTION

The present invention provides a device for processing a three dimensional (3D) image reconstruction form plural of two dimensional (2D) images in succession which comprises:
(a) means for analyzing gray scale of different tissues or areas in 2D images to determine various parameters corresponding to the tissues or areas;
(b) means for selecting one determined parameter representing a specific tissue or area;
(c) means for extracting a separate image from plural of 2D images; and
(d) means for reconstructing the 3D image from plural of the separate images.

The present invention also provides a method for reconstructing a three dimensional (3D) image form plural of two dimensional (2D) images in succession which comprises:
(a) analyzing gray scale of different tissues or areas in 2D images to determine various parameters corresponding to the tissues or areas;
(b) selecting one determined parameter representing a specific tissue or area;
(c) extracting a separate image from plural of 2D images; and
(d) reconstructing the 3D image from plural of the separate images.

### DETAILED DESCRIPTION OF THE INVENTION

The purpose of the invention is to hope doctors can use their personal computers through the movement of the mouse and buttons to rotate, zoom in or cut 3D images or directly to observe 3D patterns of organs in patients' bodies from different angles before doctors make a surgical operation to open body cavities. Besides they still can simulate all different kinds of operations through their personal computers. For example, they incise a patient's brain through 3D images, and then they take out a part to zoom in to observe narrowly or incise furthermore. If they think the sample of incision unfavorable, they can re-sample by incising. Every act can be operated continuously and the result can be examined immediately. The system offers calculation and measurement functions such as the volume of a tumor or the length of a crack inside the bone. These are never achieved in a practical operation, but the system can be utilized to simulate a previous surgical operation and improve doctor's proficiency, accuracy and precision of surgical operations. Meanwhile the device is also used to educate and train medical students or clinical doctors. For example, a patient's condition is diagnosed more precisely, a proper treatment is worked out, a patient's wound is perfectly dealt with and neighbor important organs aren't wounded, and a rehabilitation plan after the operation is made.

Current 2D medical image techniques in the market are roughly magnetic resonance imaging (MRI), positron emission tomography (PET), positron emission tomography/computed tomography (PET/CT), ultra-sound (US) and computed tomography (CT). The image technique of the present invention is functional MRI, which plays a certain role in estimation before a brain surgical operation. Other current functional image techniques such as PET are too expensive to afford by a general hospital. Hence the general examination cannot provide a high level service. To the contrary, functional MRI not only provides shorter scanning time but also makes high contrast images for soft tissues without radiation problem.

The present invention provides a device for processing a three dimensional (3D) image reconstruction form plural of two dimensional (2D) images in succession which comprises:
(a) means for analyzing gray scale of different tissues or areas in 2D images to determine various parameters corresponding to the tissues or areas;
(b) means for selecting one determined parameter representing a specific tissue or area;
(c) means for extracting a separate image from plural of 2D images; and
(d) means for reconstructing the 3D image from plural of the separate images.

In the present invention, the gray scale is classified between 2⁹ and 2¹¹layers. In the preferred embodiment of the present invention, the gray scale is 2¹⁰ layer.

In the present invention, the determined parameter representing the tissue or area is identified by measuring the gray scale of the tissue or area in the 2D image.

The tissue used herein means a normal tissue (such as brain, heart, kidney, lung, skeleton, muscle, spinal cord, digestive organs, urinary organs, ear, nose, throat, visual system or circulatory system) or pathologic tissue (such as tumor, hemorrhage, hemangiomata, brain tumor, inflammation, infarct, necrosis, cavities or calcification). In the preferred embodiment of the present invention, the brain including cortex (gray matter), medulla (white matter), ventricles or cerebral blood vessels could be analyzed.

In the present invention, the 2D image could be obtained from CT, MRI, functional MRI, PET, SPET, ultrasound, pathological section or dyeing section.

### Computed Tomography (CT)

The technique which was called computerized axial transverse scanning at that time is to acquire section images through reverse-projection and recombination of images by computer after detecting the amount of gamma-ray through a patient which is called projection with a point source and a single detector. The developing process of CT is how to get better images with least time, which is as a starting point. With the improver of computer speed, dealing operations are getting more complex. In the present data acquired from spiral CT are no longer sectional data but volumetric data which can be recombined to get images of any sections by computer. In the part of image displaying, it also gets 3D images through 3D reconstruction. Besides, it can turn gray-level images colorful and increase the resolution of color levels to provide convenience to dialogize by pseudo-color.

### Ultra-Sound (US)

The present Ultrasound scanners are all real-time scanners. The chips within their probes or transducers are provided with piezoelectric effect, which can regard as disseminators or receptors and interchange mechanic energy (sound wave) with electric energy. The sound wave which was generated by electric shocking chip within the probe of US spreads in a medium. When the sound wave passes through the interface formed by two different sound impedance materials, part of the wave sound is refluxed to the probe. The reflex wave or echo is transformed into electric signals and then an image is formed by digitalization with an instrument. It's the newest clinical development of US in the next century that includes the use of ultrasound imaging agents (developers), 3D imaging of US, harmonic images and light US scanners which are similar to handy notebook computers, which will make an influence as a handset to improve service, examination and diagnostic quality.

In the developing process of digital images with CT, MRI and US, higher resolution is offered, scanning speed is faster and comfort of patients is increased. At the same time it also develops images from 2D into 3D to more clearly recognize the relative positions of tissue or organs.

### Single Photon Emission Computed Tomography (SPECT)

The basic principle of Single Photon Emission Computed Tomography (SPECT) is similar to general nuclear medical scan. The difference is 3D static emission tomography with 360 degrees against specific tissue or organs. The images acquired involve 3D and three sectional images and what they offer is mainly the functional information of specific human tissue or organs. Sometimes they also offer the messages about physiology, biochemistry, metabolism and quantitative analysis, etc in humans.

### Positron Emission Tomography (PET)

Positron Emission Tom Tomography (PET) is a fast-developing and brand-new image diagnostic technique in nuclear medicine in recent years. Its method is to use the PET to measure nuclear medical medicaments labeled by positron emitting radionuclide and injected by intravenous injection or inhaled into humans after a period of time. So that the radioactive tracer distribution or if the metabolism is abnormal is recognized. The nuclear medical medicaments used by PET almost belong to labeled agents of life substrates with high specific or their derivates. The radioactive concentration of per-unit volume can be measured against specific tissue or organs by quantitative analysis to recognize the metabolism of specific tissue or organs against the specific medicaments and then furthermore to understand the pathologic mechanism of the disease. Hence what PET can offer is the information about physiology, biochemistry and metabolism of specific tissue or organs in humans and the relative positions of anatomic structures. Because the physiology, biochemistry and metabolism are changed before anatomic structures are changed in the initial stage of the most human diseases, PET can precisely offer multilateral qualitative and quantitative information in the initial stage of diseases. PET belongs to 3D emission tomography so the images acquired are those involving 3D and three sectional images, wherein the quality of the images and the resolution are both better than general nuclear medical scan and SPECT. There is no radioactivity except nuclear medical medicaments and the instrument self with a few radio activities so the whole examining process doesn't hurt patients at all and even achieve the function of initial diagnosis and initial treatment.

### Magnetic Resonance Imaging (MRI)

The basis principle of Magnetic Resonance Imaging (MRI) is to utilize the atomic nucleus with odd protons such as hydrogen nucleus widely exists in human bodies, whose protons as magnetic bodies spin and are charged positive to generate magnetic torque. The spinning axes of the magnetic bodies don't arrange regularly. However when in a homogeneous strong magnetic field, the axes of the magnetic bodies will re-arrange with the direction of magnetic line of the magnetic field. Under the situation, the radiofrequency pulse with a specific frequency is used to excite and then hydrogen nucleus as magnetic bodies absorbs certain amount of energy to resonate, which is called magnetic resonance. While stopping radiofrequency pulse, the energy absorbed by excited hydrogen nucleus is gradually released, and then the phase and the energy level both return to the former status. The restoring process is called relaxation and the time of restoring to the original status is called relaxation time. There are two kinds of relaxation time. One is spin-lattice relaxation time also called longitudinal relaxation time, which reflects the time of transmitting the absorbed energy from spinning nucleus to neighbor lattice, namely, the time that 90 degrees radiofrequency pulse protons spends from longitudinal magnetization through transverse magnetization then into longitudinal magnetization. The time is called T1. The other is spin—spin relaxation time also called transverse relaxation, which reflects the process of transverse magnetization decrease and loss, namely, the time of maintaining transverse magnetization. This is called T2. T2 decrease is generated by inter-magnetization among resonant protons, which is different from T1. T1 generates the phase change.

T1 of normal tissue and T1 of pathologic tissue in different human organs are relatively fixed and there is a specific difference between them and so is T2 (Table 1-1a, 1-1b). The differences of relaxation time between tissues are the principle of MRI.

The imaging method of MRI is similar to CT. Nevertheless although the images of MRI are displayed in the form of different gray-levels, what they reflect is the difference of the signal strength of MR or the length of relaxation time T1 and T2. It's not the tissue density that the gray-levels reflect like computed tomography.

The imaging method of MRI is as follows. The examining levels are separated into a certain number of small volumes in Nx, Ny, Nz, wherein the volume is called vowel. Messages are collected by receiver and are input into the computer to calculate after they are numberlized. T1 or T2 of every vowel acquired is proceeded to be 3D encoded. Every T-value is transformed into simulate gray scales by transformer and furthermore images are reconstructed. Data collection, operation and image displaying in MRI instruments except that image reconstruction is through Fourier Transform instead of reverse-projection are much similar to computed tomography.

TABLE 1-1a
T1 value of human normal tissue and pathologic tissue (ms)

| | | | |
|---|---|---|---|
| liver | 140~170 | meningioma | 200~300 |
| pancreas | 180~200 | hepatocellular | 300~450 |
| | | carcinoma | |
| kidney | 300~340 | liver hemangioma | 340~370 |
| bile | 250~300 | pancreas cancer | 275~400 |
| blood | 340~370 | kidney cancer | 400~450 |
| adipose | 60~80 | cystic lung | 400~500 |
| muscle | 120~140 | bladder cancer | 200~240 |

TABLE 1-1b
T1 value and T2 value of normal cranium and brain (ms)

| Tissue | T1 | T2 |
|---|---|---|
| Corpus Callosum | 380 | 80 |
| Pons | 445 | 75 |
| Medulla Oblongata | 475 | 100 |
| Cerebellum | 585 | 90 |
| Cerebrum | 600 | 100 |
| Cerebrospinal Fluid (CSF) | 1155 | 145 |
| Epicureanism | 235 | 60 |
| Spinal Cord | 320 | 80 |

The area used herein means the tissue profile or infiltration selected from the group consisting of tumor, lipid, lymph, connective tissue, fiber, hemorrhage, trauma, fracture, infraction of stroke patient, subdural hematoma, hemorrhagic stroke, ischemic stroke, AVM hemorrhage, intracranial aneurysm, brain tumor, meningioma, malignant brain tumor or abscess.

The device of the present invention further comprises a means for measuring volume of a specific tissue or area from the reconstructed 3D image.

The device of the present invention further comprises a means for providing histogram data by measuring volume of a specific tissue or area from the reconstructed 3D image.

The present invention also provides a method for reconstructing a three dimensional (3D) image form plural of two dimensional (2D) images in succession which comprises:
(a) analyzing gray scale of different tissues or areas in 2D images to determine various parameters corresponding to the tissues or areas;
(b) selecting one determined parameter representing a specific tissue or area;
(c) extracting a separate image from plural of 2D images; and
(d) reconstructing the 3D image from plural of the separate images.

The method of the present invention further comprises a step for measuring volume of a specific tissue or area from the reconstructed 3D image.

The method of the present invention further comprises a step for providing histogram data by measuring volume of a specific tissue or area from the reconstructed 3D image.

The image processing methodology described here may also be applied to other parts of the human body, such as the heart, liver, and kidney. Using such high resolution grayscale leveling, image segmentation, and 3D processing techniques, physicians can reconstruct high-fidelity 3D digital images for a wide variety of clinical uses, such as medical decision-making, surgical planning, psychological analysis, and prognosis assessment.

An important procedure in our technique that differs from conventional MRI scans is the precision of the scanning process. A conventional MRI scan usually takes 5 mm thick slices for a total of 20 to 25 slices per scan. The new 3D neuroimage processing used delicate scanning, with slices of 1.5 mm or less, for a total of 80 to 120 slices. This permitted a precise reconstruction of high-resolution digital 3D images and gray scale leveling for separate components of the human brain. Produce more delicate scans simply required an adjustment of the scanning parameters on a conventional MRI.

Using the technique we describe above, an independent workstation may provide an efficient, effective, and low cost approach to clinical applications of 3D image reconstruction. Through a secure internet connection, it is also possible for a central laboratory may function as an outsourcing center for 3D image reconstruction.

### EXAMPLE

### Example

### The Scanning Method of MRI

MRI scanning parameters of the brain:

The patient's position: supine

Coils: the head

T1 weighted images: 3D spoiled gradient recalled acquisition in steady state

(SPGR) resolution

TR=33 ms

Echo time =3.0 ms

Flip angle=35 degrees

Bandwidth=15.63

NEX (number of excitations): 1

Matria: 256*192 Zip512

Field of view (FOV): 22 cm

Image slice thickness: 1 mm

Scanning region: whole brain

First, apparatus for analyzing gray scale of white matter, gray matter, ventricle and vascular vessel in 30 slices of 2D images were applied to determine the parameter corresponding to the white matter, gray matter, ventricle and vascular vessel. In the example, the parameter for analyzing gray scale of white matter was 500. Then, 30 separate images from 30 slices of 2D images were extracted. Finally, these 30 separate images were constructed to form 3D image. Further, based on the reconstructed 3D image, the volume and histogram data of white matter were analyzed.

To begin, we set up the indicator for MRI scanning to a mode suitable for 3D reconstruction on a GE 1.5 T excite machine. The brain was scanned using transverse planes of 1.5 mm or less in order to obtain at least 80-120 slices. The scans were collected for algorithmic reconstruction and transmitted from a magnetic resonance unit database to an established workstation. The 3D Amira software system (version 3.1.1, Mercury Computer Systems, Inc., USA) was then used for image processing.

Image files were imported into the 3D Amira software for image segmentation. The regions of interest were identified using the software's “brush” and “wrapper” tools. The skull component of the brain was visually removed from the regions of interest by using an arithmetic module to isolate the cerebrum component.

The grayscale values were limited to 75-95 of 1024 (2¹⁰) scales in order to approximate the boundary of the gray matter. Use of the software's “threshold” tool and “edge detection” features allowed for a precise delineation of the gray matter. Certain areas of less than 50 pixels (area <0.1 cm²) were removed in order to eliminate erroneously identified gray matter. The procedure is then repeated for the white matter, ventricles, blood vessels, and brain lesions.

Subsequently, volumetric measurements of the gray matter were computed using the following formula: Volume of cortex=(Number of voxels within cortex)×(Volume per voxel). This formula can be modified to compute the volume of white matter, ventricles, and pathological lesions. Volume measurements are especially useful in the cases of brain trauma, atrophy, storage disease, senile brain atrophy, and especially psychological studies.

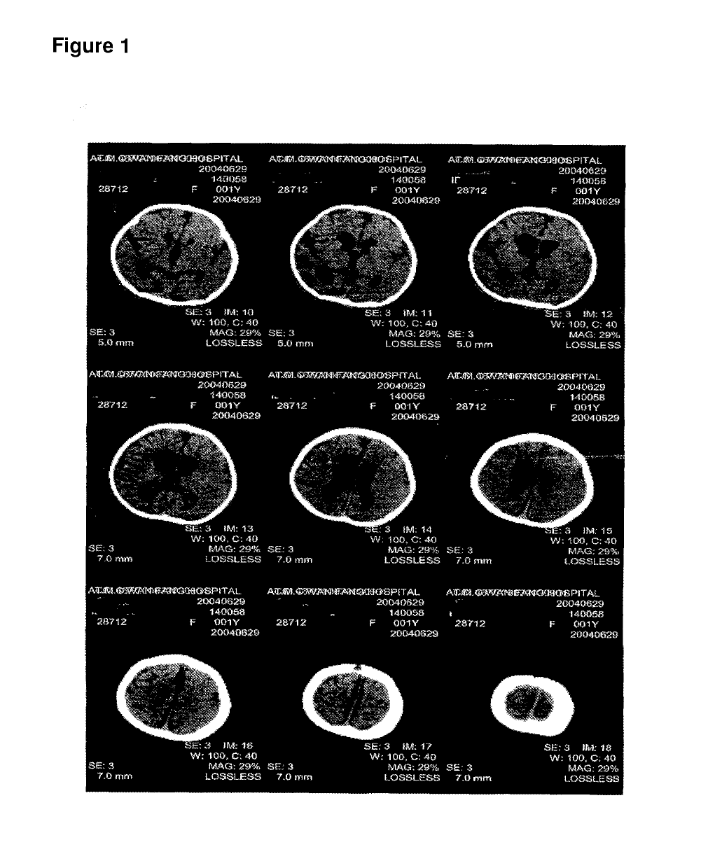

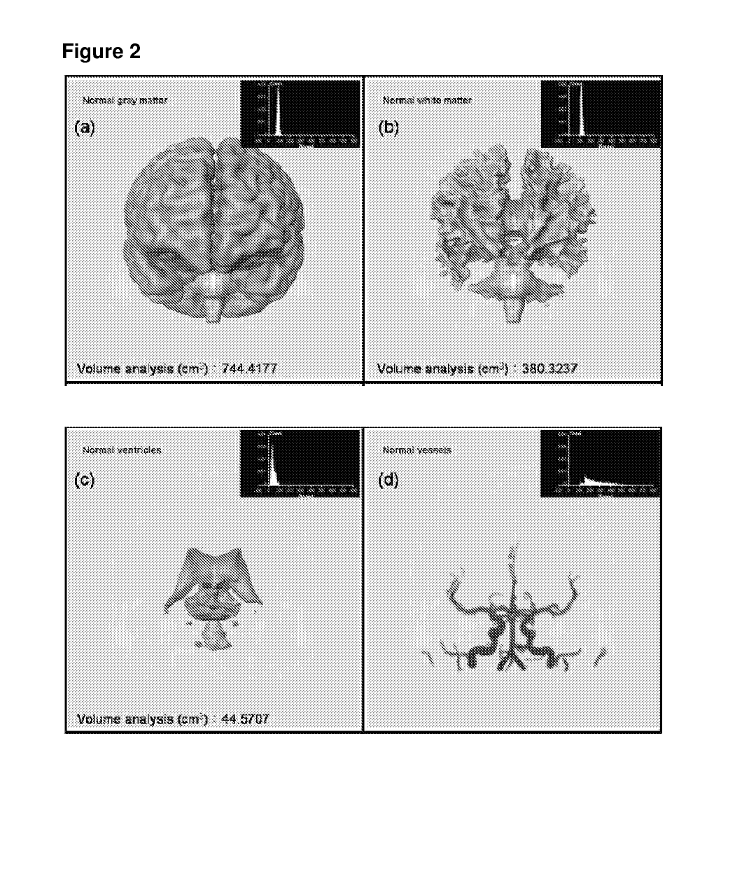

After the completion of image segmentation (FIG. 1), the regions of interest (ROI) were isolated within areas of the gray matter, white matter, ventricles, and vessels for histogram analysis. The ROI in each area was defined, and the number of voxel attenuation (MRI signal numbers) of the ROI was counted. The histogram ploted voxel attenuation along the x-axis and the number of voxels at each attenuation valued along the y-axis. The brightness signals in the T1W and T2W images were consistent with the characteristics of brain tissue. Histogram analysis of the signal brightness on a grayscale MRI image was determined according to the nature and pathology of a brain lesion (FIG. 2).

Since May of 2005, all of the MRI scans taken in the department of Pediatrics at a hospital were sent for a 3D neuroimage processing study, with a total of 161 cases collected in one year. Cortical lesions are prominent in cases with congenital CNS malformation, hypoxic ischemic encephalopathy, meningitis, encephalitis, cerebral infarction (middle cerebral artery), and cortical atrophy. White matter lesions are noted mainly in cases of periventricular leukomalacia (PVL), hypoxic insults, CNS infection, cerebral infarction, as well as congenital CNS malformation such as corpus callosum dysgenesis. Ventricular dilatation is seen in hydrocephalus, periventricular destruction lesion, and ventricular dilatation due to brain atrophy. Extra-brain lesions are noted in arachnoid cyst and subdural hemorrhage.

What is claimed is:

1. A device for processing of a three dimensional (3D) image reconstruction form plural of two dimensional (2D) images in succession which comprises:
(a) means for analyzing gray scale of different tissues or areas in 2D images to determine various parameters corresponding to the tissues or areas;
(b) means for selecting one determined parameter representing a specific tissue or area;
(c) means for extracting a separate image from plural of 2D images; and
(d) means for reconstructing the 3D image from plural of the separate images.

2. The device of claim 1, wherein the gray scale is classified between 2⁹ and 2¹¹ layers.

3. The device of claim 2, wherein the gray scale is 2¹⁰ layer.

4. The device of claim 1, wherein the determined parameter representing the tissue or area is identified by measuring the gray scale of the tissue or area in the 2D image.

5. The device of claim 1, wherein the tissue is a normal or pathologic tissue.

6. The device of claim 5, wherein the normal tissue is selected from the group consisting of brain, heart, kidney, lung, skeleton, muscle, spinal cord, digestive organs, urinary organs, ear, nose, throat, visual system or circulatory system.

7. The device of claim 6, wherein the brain includes cortex (gray matter), white matter, ventricles or cerebral blood vessels.

8. The device of claim 5, wherein the pathologic tissue is tumor, hemorrhage, hemangiomata, inflammation, infarct, necrosis, cavities or calcification.

9. The device of claim 1, wherein the 2D image is obtained from CT, MRI, functional MRI, PET, SPET, ultrasound, pathological section or dyeing section.

10. The device of claim 1, wherein the area is the tissue profile or infiltration selected from the group consisting of tumor, lipid, connective tissue, hemorrhage, trauma, infraction of stroke patient, subdural hematoma, hemorrhagic stroke, ischemic stroke, AVM hemorrhage, intracranial aneurysm, malignant brain tumor or abscess.

11. The device of claim 1, further comprises a means for measuring volume of a specific tissue or area from the reconstructed 3D image.

12. The device of claim 1, further comprises a means for providing histogram data by measuring volume of a specific tissue or area from the reconstructed 3D image.

13. A method for reconstructing a three dimensional (3D) image form plural of two dimensional (2D) images in succession which comprises:
(a) analyzing gray scale of different tissues or areas in 2D images to determine various parameters corresponding to the tissues or areas;
(b) selecting one determined parameter representing a specific tissue or area;
(c) extracting a separate image from plural of 2D images; and
(d) reconstructing the 3D image from plural of the separate images.

14. The method of claim 13, wherein the gray scale is classified between 2⁹ and 2¹¹layers.

15. The method of claim 13, wherein the determined parameter representing the tissue or area is identified by measuring the gray scale of the tissue or area in the 2D image.

16. The method of claim 1, wherein the tissue is a normal or pathologic tissue.

17. The method of claim 16, wherein the normal tissue is cortex (gray matter), white matter, ventricles or cerebral blood vessels.

18. The device of claim 16, wherein the pathologic tissue is tumor, hemorrhage, hemangiomata, inflammation, infarct, necrosis, cavities or calcification.

19. The method of claim 13, further comprises a step for measuring volume of a specific tissue or area from the reconstructed 3D image.

20. The method of claim 13, further comprises a step for providing histogram data by measuring volume of a specific tissue or area from the reconstructed 3D image.
